(19) United States
(12) Patent Application Publication
(10) Pub. No.: US 2006/0105220 A1
(43) Pub. Date: May 18, 2006

(54) Bipolar fuel cell board

(76) Inventors: Hsi-Ming Shu, Taipei (TW); Feng-Yi Deng, Taipei (TW); Tsang-Ming Chang, Taipei (TW); Weili Huang, Taipei (TW)

Correspondence Address: G. LINK Co., LTD, 3550 Bell Road, MINOOKA, IL, 60447, US

(21) Appl. No.: 11/102,232

(22) Filed: Apr. 11, 2005

(30) Foreign Application Priority Data
Nov. 18, 2004 (TW) 093218517

(51) Int. Cl. H01M 8/02; H01M 8/24; H01M 8/10

(52) U.S. Cl. 429/34; 429/30; 429/32

(57) ABSTRACT

The present invention is related to a bipolar fuel cell board, which integrates electronic devices into the single plate of bipolar fuel cell board. Bipolar fuel cell board comprises anode current collection board, cathode current collection board at least one or above one membrane electrode assembly. The membrane electrode assemblies are closely sandwiched between anode current collection board and cathode current collection board. The present invention is characterized in that at least one electronic device is placed on a bipolar fuel cell board.

### FIELD OF THE INVENTION

The present invention is related to a bipolar fuel cell board, especially to a single plate of bipolar fuel cell board integrating electronic devices.

### BACKGROUND OF THE INVENTION

The circuitry used to operate the fuel cell in the conventional fuel cell apparatus, such as energy management circuit, fuel temperature/fuel concentration/fuel liquid level sensing circuit and fuel flux control, utilizes the external connection or additional layer structure to separate from membrane electrode assembly layer in distance so as to electrically connect the circuitry to membrane electrode assembly layer by the cable or by the electrically conducting through holes in necessity. It is disadvantageous for the structure of the conventional fuel cell apparatus to make the membrane electrode assemblies of the fuel cell board have to connect to the external circuit so as to make the fuel cell board fail to be modularized and even be an obstacle to miniaturize the fuel cell board in integral volume.

The inventor investigates the disadvantages of the fuel cell board used in the conventional fuel cell apparatus and desires to improve and invent a single bipolar fuel cell board integrating electronic devices.

### SUMMARY OF THE INVENTION

The main object of the present invention is to provide a single bipolar fuel cell board integrating electronic devices.

To achieve the above objects, the present invention provides a bipolar fuel cell board, comprising: an anode current collection board, a cathode current collection board, at least one or more membrane electrode assembly which is closely sandwiched between the anode current collection board and the cathode current collection board, and is characterized in that at least one electronic device is placed on the bipolar fuel cell board.

### BRIEF DESCRIPTION OF THE DRAWINGS

The above objects and advantages of the present invention will become more apparent with reference to the appended drawings wherein:

FIG. 1 shows the structural figure of the bipolar fuel cell board of the present invention;

FIG. 2 shows the first embodiment based on the structure of bipolar fuel cell board in FIG. 1;

FIG. 3 shows the second embodiment based on the structure of bipolar fuel cell board in FIG. 1;

FIG. 4 shows the third embodiment based on the structure of bipolar fuel cell board in FIG. 1; and

FIG. 5 shows the structural figure of the electrical interface in advance placed on bipolar fuel cell board in FIG. 1.

### DETAILED DESCRIPTION OF THE INVENTION

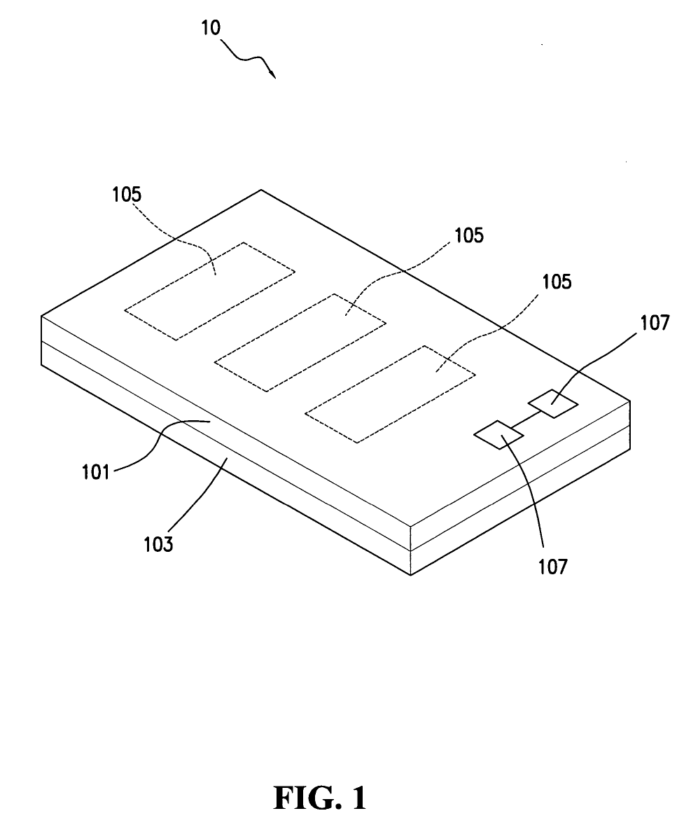

FIG. 1 shows the structural figure of the bipolar fuel cell board of the present invention. The present invention bipolar fuel cell board 10 mainly includes anode current collection board 101, cathode current collection board 103 and at least one or above one membrane electrode assembly 105 which are respectively described thereinafter. The implemented means of the present invention anode current collection board 101 and cathode current collection board 103, for instance, being capable of using print circuit board (PCB) substrate like the substrate with double-sided cooper foils, proceeds the process of PCB to etch the outer and inner cooper foils of the substrate with double-sided cooper foils and then respectively produces anode current collection board 101 and cathode current collection board 103. Furthermore, the surfaces of these current collection circuitries 101a, 103a contacted with the membrane electrode assemblies 105 are able to in advance proceed protection and anti-corrosion treatments in order to avoid the damage of current collection circuitries by the product of fuel or electrochemical reaction, and the implemented means to protect or anti-corrosion is able to use coatings with conductive metal materials which are selected from the alloy made of gold and carbon or metal material. Meanwhile, the implemented means used to protect or anti-corrosion the surfaces of these current collection circuitries 101a, 103a on the outer sides of the current collection boards 101, 103 is able to use the coating process like the coating of metal material or non-metal material. The membrane electrode assemblies 105 are closely sandwiched between the anode current collection board 101 and cathode current collection board 103. The present invention is mainly characterized in that at least one electronic device 107 is placed inside the bipolar fuel cell board 10, and accordingly the membrane electrode assemblies 105 are able to produce electricity after acquiring the supplies of anode fuel and cathode fuel. The bipolar fuel cell board 10 also has the function of integrating circuitry besides possessing the function of producing electricity, and again increases the power supply quality of the bipolar fuel cell board 10 by way of the electronic circuitry formed by the electronic devices 107.

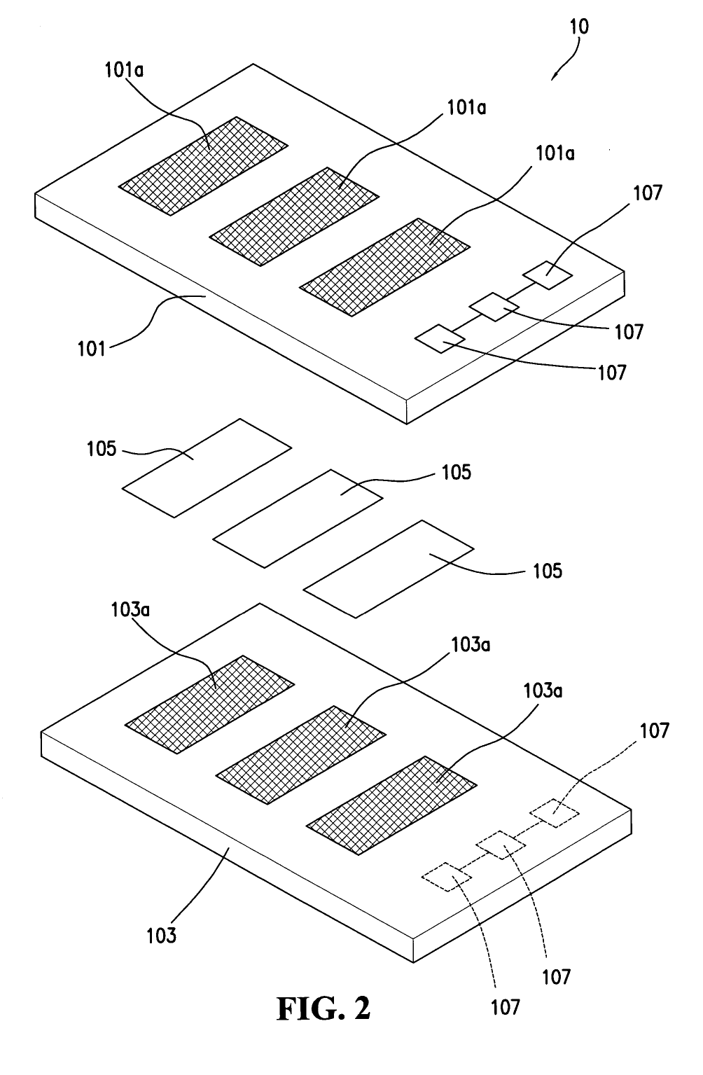

FIG. 2 shows the first embodiment based on the structure of bipolar fuel cell board in FIG. 1. In FIG. 2, the electronic devices 107 are directly placed on the outer surface of the anode current collection board 101 or directly placed on the outer surface of the cathode current collection board 103. The process to respectively manufacture the anode current collection board 101 and cathode current collection board 103 is to use the PCB process by forming the current collection circuitries 101a and 103a on the copper foils of the substrate with double-sided copper foils and forming the layout on the outer copper foils of the substrate, and then solders the electronic devices 107 upon the layout. In assembling the bipolar fuel cell board 10 in FIG. 2, the step is laminated and piled-up the anode current collection board 101, membrane electrode assemblies 105 and the cathode current collection board 103 in order from top to down, and then uses the bonding means to form a single plate of bipolar fuel cell board 10.

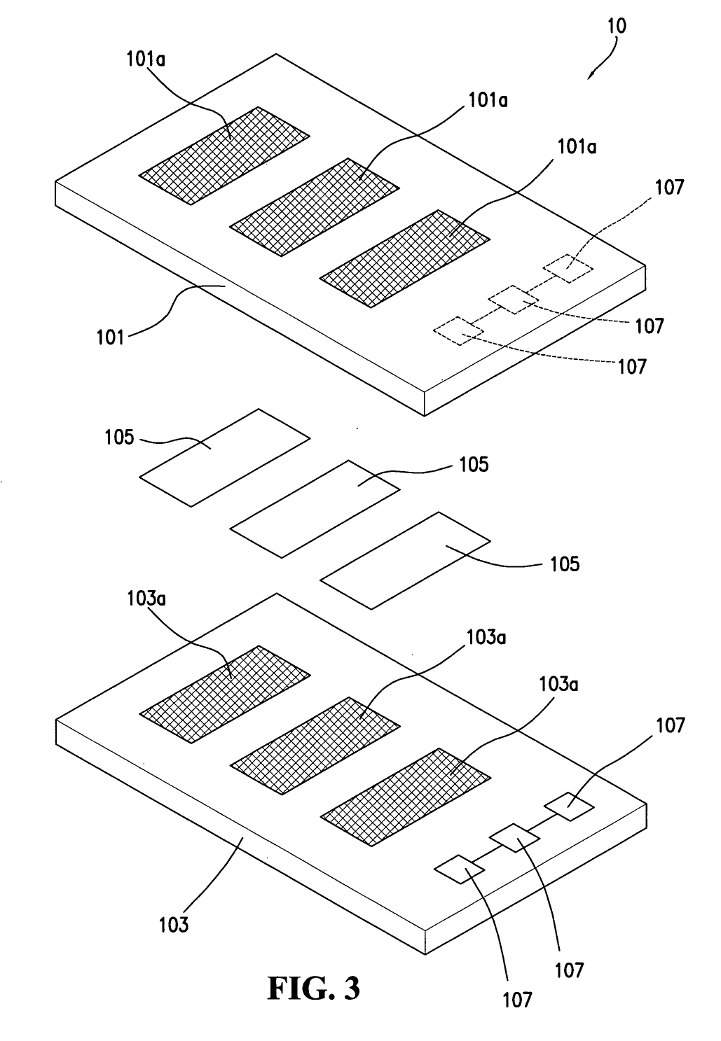

FIG. 3 shows the second embodiment based on the structure of bipolar fuel cell board in FIG. 1. In FIG. 3, the electronic devices 107 are directly placed on the inner surface of the anode current collection board 101 or directly placed on the inner surface of the cathode current collection board 103. The process to respectively manufacture the anode current collection board 101 and cathode current collection board 103 is to use the PCB process by forming the current collection circuitries 101a and 103a on the copper foils of the substrate with double-sided copper foils and forming the layout on the inner cooper foils of the substrate, and then solders the electronic devices 107 upon the layout. In assembling the bipolar fuel cell board 10 in FIG. 3, the step is laminated and piled-up the anode current collection board 101, membrane electrode assemblies 105 and cathode current collection board 103 in order from top to down, and then uses the bonding means to form a single plate of bipolar fuel cell board 10.

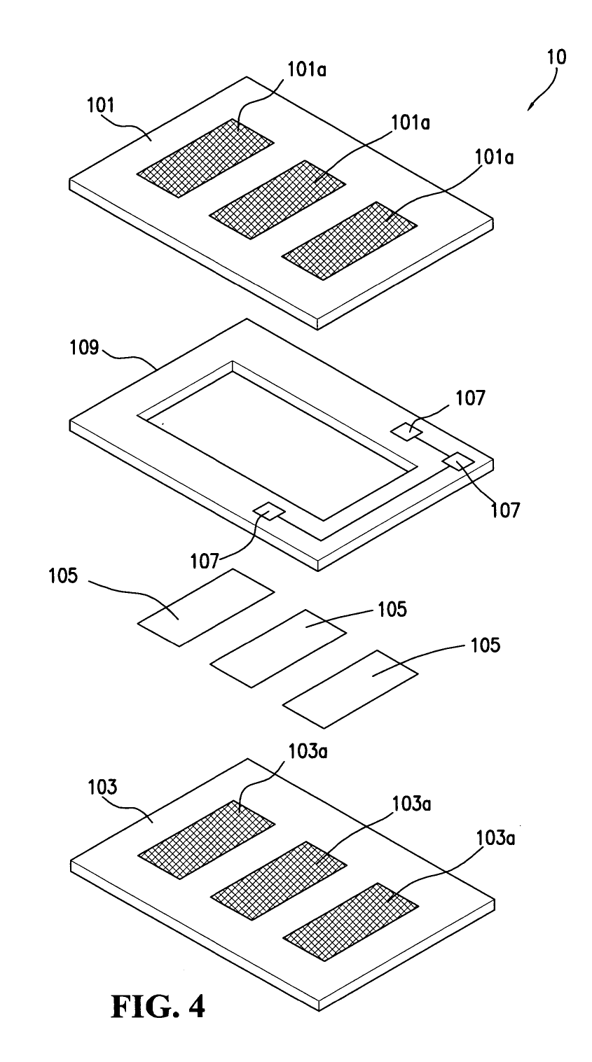

FIG. 4 shows the third embodiment based on the structure of bipolar fuel cell board in FIG. 1. In FIG. 4, the electronic devices 107 are directly placed on the surface of the mediate substrate 109, the mediate substrate 109 is able to use flexible circuit board and proceeds with the PCB process to form the layout and then solders the electronic devices 107 upon the layout. The mediate substrate 109 is able to use ‘□’ shape so as to put membrane electrode assemblies 105 into the hollow area of the mediate substrate 109. In assembly, the step is laminated and piled-up the anode current collection board 101, membrane electrode assemblies 105, mediate substrate 109 and cathode current collection board 103 in order from top to down, and then uses the bonding means to form a single plate of bipolar fuel cell board 10.

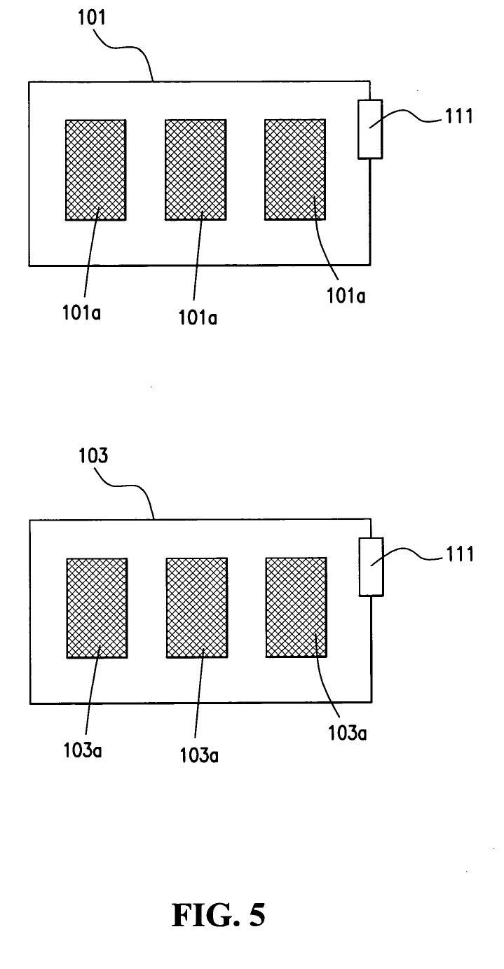

FIG. 5 shows the structural figure of the electrical interface in advance placed on bipolar fuel cell board in FIG. 1. The electrical interface 111 is placed on a side edge of the anode current collection board 101 or a side edge of the cathode current collection board 103, and also the electrical interface 111 is electrically connected to membrane electrode assemblies 105 and the electronic devices 107, and again the implemented means of the electrical interface 111 is using like the golden fingers and connectors.

The present invention electronic device 107 is capable of being an active device, passive device, sensing device, integrated circuit device, micro-controller, sensor, constant voltage regulator and constant current regulator. The embodiment of the sensing device is arbitrary one of the concentration sensor, liquid level sensor, temperature sensor, voltage sensor and current sensor. The embodiment of the active device is arbitrary one of the concentration controller, liquid level controller, temperature controller, voltage controller and current controller.

The present invention bipolar fuel cell board has the following advantages and improvements:
1. The present invention bipolar fuel cell board integrates the key components and electronic devices used in the fuel cell to produce the electricity into a single plate (one piece) to make bipolar fuel cell apparatus possessing a smart feature by way of the circuitry function of the electronic device; and
2. The present invention bipolar fuel cell is a single plate structure which has circuitry functions in itself so as to strongly possess a modularized feature.

Although the present invention has been disclosed in one embodiment as above, it does not imply to limit the present invention, any person who is skilled in the art could make any change or modification within the spirit and scope of the present invention, however, it belongs to the scope of the present invention, and the protective scope of the present invention is defined by the following claims.

What is claimed is:

1. A bipolar fuel cell board, comprising: an anode current collection board; a cathode current collection board; at least one or above one membrane electrode assembly which closely sandwiched between the anode current collector board and the cathode current collection board, is characterized in that at least one electronic device is placed on the bipolar fuel cell board.

2. The bipolar fuel cell board according to claim 1, wherein the electronic device is chosen from a group consisting of an active electronic device, a passive electronic device, a sensing device, an integrated circuit device, a microcontroller, a sensor a voltage regulator, and a constant current regulator.

3. The bipolar fuel cell board according to claim 1, wherein the electronic devices are placed on the anode current collection board.

4. The bipolar fuel cell board according to claim 1, wherein the electronic devices are placed on the cathode current collection board.

5. The bipolar fuel cell board according to claim 1, wherein the electronic devices are closely sandwiched between the anode current collection board and the cathode current collection board.

6. The bipolar fuel cell board according to claim 1, wherein the electronic device are electrically connected to the membrane electrode assemblies.

7. The bipolar fuel cell board according to claim 1, wherein the bipolar fuel cell board is the bipolar fuel cell board of using gas fuel.

8. The bipolar fuel cell board according to claim 1, wherein the bipolar fuel cell board is the bipolar fuel cell board of using liquid fuel.

9. The bipolar fuel cell board according to claim 1, wherein the bipolar fuel cell board is the bipolar fuel cell board of using solid fuel.

10. The bipolar fuel cell board according to claim 1, further comprising: an electrical interface, which is placed on the bipolar fuel cell board and electrically connected to the electronic devices.

11. The bipolar fuel cell board according to claim 10, wherein the electrical interface is a set of golden fingers.

12. The bipolar fuel cell board according to claim 10, wherein the electrical interface is a connector.

13. The bipolar fuel cell board according to claim 1, further comprising: a mediate substrate, which is placed the electronic device and is closely sandwiched between the anode current collection board and the cathode current collection board.

14. The bipolar fuel cell board according to claim 1, wherein the anode current collection board comprises at least one current collection circuit, and wherein the surface of the current collection circuit is treated by the protection and/or anti-corrosion.

15. The bipolar fuel cell board according to claim 1, wherein the cathode current collection board comprises at least one current collection circuit, and wherein the surface of the current collection circuit is treated by the protection and/or anti-corrosion.

16. The bipolar fuel cell board according to claim 14, wherein the surface of the current collection circuit contacting with the membrane electrode assembly is coated with metal material with good conductivity.

17. The bipolar fuel cell board according to claim 15, wherein the surface of the current collector circuit contacting with the membrane electrode assembly is coated with metal material with good conductivity.

18. The bipolar fuel cell board according to claim 14, wherein the surface of the current collection circuit located at the external surface of the anode current collection board is coated with metal material and/or non-metal material.

19. The bipolar fuel cell board according to claim 15, wherein the surface of the current collection circuit located at the external surface of the cathode current collection board is coated with metal material and/or non-metal material.

20. The bipolar fuel cell board according to claim 16, wherein the metal material is chose from one of the alloy made of gold and carbon, and the single metal material.

21. The bipolar fuel cell board according to claim 17, wherein the metal material is chose from one of the alloy made of gold and carbon, and the single metal material.
